(19) United States
(12) Patent Application Publication
(10) Pub. No.: US 2023/0277898 A1
(43) Pub. Date: Sep. 7, 2023

(54) ELECTRONIC DEVICE AND OPERATION METHOD THEREFOR

(71) Applicant: SAMSUNG ELECTRONICS CO., LTD., Suwon-si (KR)

(72) Inventors: Kilsoo CHOI, Suwon-si (KR); Sehyun Kim, Suwon-si (KR); Jiwon Park, Suwon-si (KR); Hyunjin Park, Suwon-si (KR); Kwansik Yang, Suwon-si (KR); Jongin Lee, Suwon-si (KR)

(73) Assignee: SAMSUNG ELECTRONICS CO., LTD., Suwon-si (KR)

(21) Appl. No.: 18/197,944

(22) Filed: May 16, 2023

Related U.S. Application Data
(63) Continuation of application No. PCT/KR2021/016067, filed on Nov. 5, 2021.

(30) Foreign Application Priority Data
Nov. 16, 2020 (KR) 10-2020-0153075

(51) Int. Cl. A63B 24/00; A63B 71/06; G06T 7/20; G06T 7/70

(52) U.S. Cl. CPC A63B 24/0006; A63B 71/0622; G06T 7/20; G06T 7/70; A63B 2024/0012

(57) ABSTRACT

Provided is an electronic device and an operating method of an electronic device. The operating method of the electronic device includes obtaining object identification information of an object based on an image obtained from a camera, obtaining camera information indicating a capturing range of the camera, obtaining search information based on at least one of the object identification information and the camera information, transmitting the search information to a server, receiving a content list from the server, wherein the content list is searched based on the search information, and outputting the content list.

### CROSS-REFERENCES TO RELATED APPLICATIONS

This application is a bypass continuation of International Application No. PCT/KR2021/016067, filed on Nov. 5, 2021, which claims priority from Korean Patent Application No. 10-2020-0153075, filed on Nov. 16, 2020, in the Korean Intellectual Property Office, the disclosures of which are incorporated by reference herein in their entireties.

### BACKGROUND

### 1. Field

Various embodiments of the disclosure relate to an electronic device and an operating method thereof, and more particularly, to an electronic device for obtaining search information by using an image of a user and based on the obtained search information, recommending searched content to the user, and an operating method of the electronic device.

### 2. Description of Related Art

With the development of technologies, a television having a high-quality large screen has been developed, and the usages of the television have diversified. At-home workout for imitating exercise by watching a screen of the television is one of the usages. Users may view various exercise content through the television to watch an exercise motion of a professional trainer and imitate the exercise motion.

In certain cases, users may not know which content to select from among a lot of exercise content. Therefore, it is required to recommend appropriate content to the users so that the users may more conveniently select desired content.

### SUMMARY

According to an embodiment, an operating method of an electronic device includes obtaining object identification information of an object based on an image obtained from a camera; obtaining camera information indicating a capturing range of the camera; obtaining search information based on at least one of the object identification information and the camera information; transmitting the search information to a server; receiving a content list from the server wherein the content list is searched based on the search information; and outputting the content list.

According to an embodiment, an electronic device includes a display; a memory storing one or more instructions; and a processor configured to execute the one or more instructions stored in the memory to obtain object identification information of an object, from an image obtained from a camera; obtain camera information indicating a capturing range of the camera; obtain search information based on at least one of the object identification information and the camera information; transmit, to a server, the search information; and output, through the display, a content list, the content list being searched based on the search information and received from the server.

A non-transitory computer-readable recording medium including recorded thereon a program for implementing an operating method of an electronic device is provided. The operating method includes obtaining object identification information of an object based on an image obtained from a camera; obtaining camera information indicating a capturing range of the camera; obtaining search information based on at least one of the object identification information and the camera information; transmitting the search information to a server; receiving a content list from the server, wherein the content list is searched based on the search information; and outputting the content list.

### BRIEF DESCRIPTION OF THE DRAWINGS

FIG. 1 is a diagram for describing an electronic device recommending to a user a content list searched based on a user image, according to an embodiment.

FIG. 2 is a diagram illustrating an image of an object captured by a camera, according to an embodiment.

FIGS. 3A to 3D are diagrams for describing camera information according to an embodiment.

FIG. 4 is a block diagram showing an inner structure of an electronic device according to an embodiment.

FIG. 5 is a block diagram showing an inner structure of a processor of FIG. 4.

FIG. 6 is a block diagram showing an inner structure of an electronic device according to an embodiment.

FIG. 7 is a diagram for describing an operation of outputting, via multi-views, a motion of a user and a motion of a comparative subject included in content recommended by an electronic device, according to an embodiment.

FIG. 8 is a diagram for describing an electronic device outputting an interface screen for interaction with a user, when a body part of the user captured by a camera is changed, according to an embodiment.

FIG. 9 illustrates a case in which a real time image with respect to an object is obtained by using a plurality of cameras, according to an embodiment.

FIG. 10 is a diagram for describing an operation of outputting, via multi-views, a motion of a user and a motion of a comparative subject included in content recommended by an electronic device, when a plurality of images with respect to the user are obtained, according to an embodiment.

FIG. 11 is a diagram for describing an operation of outputting, via multi-views, a motion of a comparative subject included in content, a motion of a user, and a motion of a third party altogether, according to an embodiment.

FIG. 12 is a diagram for describing an operation of outputting, via multi-views, a motion of a comparative subject included in content, a motion of a user, and a motion of a third party altogether, according to an embodiment.

FIG. 13 is a flowchart of an operating method of an electronic device, according to an embodiment.

FIG. 14 is a flowchart of an operating method of an electronic device, according to an embodiment.

### DETAILED DESCRIPTION

Object identification information may include information about at least one of a body part of an object, a posture of the object, and a direction of the object.

Camera information may include at least one of information about a camera capability and information about a camera state, and the information about the camera state may include at least one of information about a current setting state of a camera, information about a location of the camera, and information about a mode of the camera.

The operating method may further include identifying that at least one of the object identification information and the camera information is changed, obtaining, based on the changed information, changed search information, and transmitting, to the server, the changed search information, and receiving, from the server, a content list searched based on the changed search information and outputting the received content list.

The operating method may further include outputting an interface screen configured to ask whether or not to perform a new content search, according to the identifying that the at least one of the object identification information and the camera information is changed.

The operating method may further include selecting content from the content list and outputting the selected content and a real time video with respect to the object captured by the camera, via multi-views, by using a plurality of partial screens.

The operating method may further include obtaining matching information by comparing a motion of a comparative subject included in the selected content with a motion of the object included in the real time video and outputting the matching information.

The operating method may further include receiving a real time video with respect to a third party, and the outputting of the selected content and the real time video with respect to the object captured by the camera, via multi-views, by using the plurality of partial screens may include outputting the selected content, the real time video with respect to the object captured by the camera, and the real time video with respect to the third party, via multi-views, by using the plurality of partial screens.

The camera may include a plurality of cameras, wherein the plurality of cameras capture the object in different directions, the obtaining of the search information may include obtaining search information for each of the plurality of cameras, and the receiving of the searched content list may include receiving a content list including, as a set, contents for the plurality of directions, respectively searched in correspondence to the search information obtained for each of the plurality of cameras.

The outputting of the selected content and the real time video with respect to the object captured by the camera, via multi-views, by using the plurality of partial screens may include outputting the set of contents for the plurality of directions included in the selected content and the real time video with respect to the object obtained by the camera, via multi-views, by comparing, based on an identical direction, the set of contents for the plurality of directions included in the selected content with the real time video with respect to the object captured by the camera.

An electronic device includes a communicator, a display, a memory storing one or more instructions, and a processor configured to execute the one or more instructions stored in the memory to obtain object identification information with respect to an object, from an image obtained by capturing the object via a camera, obtain camera information indicating a capturing range of the camera, obtain search information based on at least one of the object identification information and the camera information, transmit, to the server, the search information through the communicator, and output, through the display, a content list searched based on the search information and received from the server.

A computer-readable recording medium has recorded thereon a program for implementing an operating method of an electronic device, the operating method including obtaining object identification information with respect to an object, from an image obtained by capturing the object via a camera, obtaining camera information indicating a capturing range of the camera, obtaining search information based on at least one of the object identification information and the camera information, transmitting the search information to a server, receiving, from the server, a content list searched based on the search information, and outputting the received content list.

Hereinafter, an embodiment of the disclosure will be described in detail with reference to the accompanying drawings for one of ordinary skill in the art to easily execute the disclosure. However, the disclosure may have different forms and should not be construed as being limited to the embodiment described herein.

The terms used in the disclosure are common terms that are currently widely used, in consideration of their function in the disclosure. However, the terms may become different according to an intention of one of ordinary skill in the art, a precedent, or the advent of new technology. Therefore, the terms used in the disclosure should not be interpreted merely by the terms, but should be interpreted based on the meaning of the terms and the content throughout the disclosure.

Also, the terms used in the disclosure are merely used to describe a predetermined embodiment and are not aimed to limit the disclosure.

Throughout the specification, when a part is referred to as being “connected” to other parts, the part may be “directly connected” to the other parts or may be “electrically connected” to the other parts with other devices therebetween.

Expressions such as “the” and other similar referring expressions used in this specification, particularly, the claims, may refer to both singular and plural elements. Also, unless orders of operations for describing a method according to the disclosure are clearly described, the operations may be performed in appropriate orders. The disclosure is not limited to the described orders of the operations.

Expressions such as “in some embodiments” and “according to an embodiment of the disclosure” described in various parts of this specification do not necessarily refer to the same embodiment.

One or more embodiments of the disclosure may be described as functional block components and various processing operations. Part or all of such functional blocks may be realized by various numbers of hardware and/or software components configured to perform specified functions. For example, the functional blocks of the disclosure may be implemented by one or more micro-processors or by circuit structures for certain functions. Also, for example, the functional blocks of the disclosure may be implemented by various programming or scripting languages. The functional blocks may be implemented by algorithms executed by one or more processors. Furthermore, the disclosure could employ conventional techniques for electronics configuration, signal processing and/or data control. The words, such as “mechanism,” “element,” “device,” and “component,” may be used broadly and are not limited to mechanical and physical components.

In addition, connecting lines or connecting members between components illustrated in the drawings are intended to represent example functional connections and/or physical or logical connections between the components. It should be noted that many alternative or additional functional connections, physical connections or logical connections may be present in a practical device.

Also, the terms, such as “unit,” “module,” etc., described in the specification indicate a unit that processes at least one function or operation, and the unit may be embodied in a hardware manner, a software manner, or a combination of the hardware manner and the software manner.

Also, the term “user” in the specification may denote a person controlling a function or an operation of an electronic device by using the electronic device and may include a viewer, consumer, manager, or installing technician.

Hereinafter, the disclosure is described in detail with reference to the accompanying drawings.

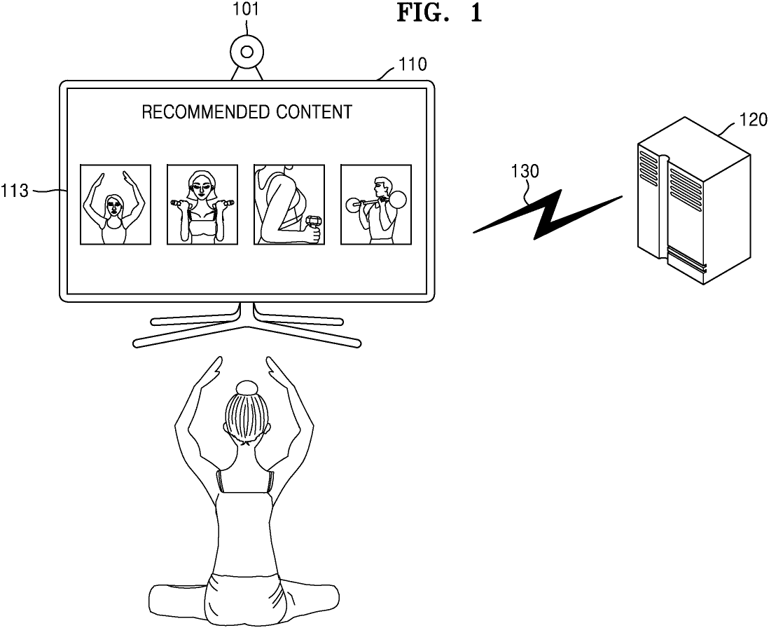

FIG. 1 is a diagram for describing an example in which an electronic device 110 recommends to a user a content list searched based on a user image, according to an embodiment.

Referring to FIG. 1, the electronic device 110 may transmit and receive information to and from a server 120 through a communication network 130.

According to an embodiment, the electronic device 110 may be a display device capable of outputting content. The electronic device 110 may be a television (TV), but is not limited thereto and may be realized as various types of electronic devices including a display.

According to an embodiment, the electronic device 110 may include a camera 101. The camera 101 may be included in the electronic device 110 as an integral type or may be connected to the electronic device 110 as a separate device from the electronic device 110. The camera 101 may obtain a real time image by capturing a user.

The electronic device 110 may analyze the image obtained through the camera 101 and obtain search information based on the analyzed image.

According to an embodiment, the electronic device 110 may obtain object identification information from the image obtained through the camera 101. The object identification information may denote information used to identify an object. When an object is a human being, the object identification information may include information used to identify a body of the human being. The object identification information may include information about at least one of a body part of the object, a posture of the object, and a direction of the object.

In FIG. 1, by analyzing the image obtained through the camera 101, the electronic device 110 may identify that the body part of the object included in the image is the upper body. Also, by analyzing the image, the electronic device 110 may identify that the object is in a sitting posture. Also, by analyzing the image, the electronic device 110 may identify that the direction of the object is toward a front side of the camera 101.

According to an embodiment, the electronic device 110 may obtain camera information. The camera information may denote information about a capturing range of the camera 101. The camera information may include at least one of information about a camera capability and information about a camera state.

The information about the camera capability may denote information indicating a characteristic or the performance of the camera 101, related to the capturing range of the camera 101. The information about the camera capability may include information related to various specifications of the camera 101. For example, the information about the camera capability may include information about whether the camera 101 provides a zoom function, a wide-angle function, a depth function, etc.

The information about the camera state may be information indicating a current state of the camera 101, the current state being related to a current capturing range of the camera 101, and may include at least one of information about a mode of the camera 101, information about a mounting location of the camera 101, and information about a current setting state of the camera 101. For example, it is assumed that the camera 101 illustrated in FIG. 1 supports a wide-angle function. Here, the information about the camera capability may include information indicating that the corresponding camera 101 supports a wide-angle function.

Also, in FIG. 1, the camera 101 is located above the electronic device 110. The above location of the camera 101 may denote that the camera 101 is in a state appropriate for capturing upper body motions of a user.

Also, it is assumed that the camera 101 illustrated in FIG. 1 currently performs the wide-angle function. That the wide-angle function is being performed may denote that because an angle of view of capturing of the camera 101 is greater than a reference angle of view, the camera 101 is in a state appropriate for capturing a plurality of people altogether or appropriate for capturing motions of right and left movement. The electronic device 110 may obtain this type of information as the information about the camera state. That is, the electronic device 110 may obtain information indicating a current location of the camera 101 and information indicating that a wide-angle function is currently used by the camera 101 as the information about the camera state.

According to an embodiment, the electronic device 110 may obtain the search information based on at least one of the object identification information and the camera information. The electronic device 110 may transmit the search information to the server 120 through the communication network 130.

The server 120 may store various content generated by content providers. The content providers may include ground wave broadcasting stations, cable broadcasting stations, over-the-top (OTT) service providers, Internet protocol television (IPTV) service providers, etc. The OTT service providers or the IPTV service providers may provide various content to consumers by using Internet protocols on a broadband connection. These service providers may provide a streaming service, thereby allowing the consumers to use live broadcasting in real time, or may provide a video on demand (VOD) service, thereby allowing the consumers to receive and use streams of desired content, at desired times, via streaming or downloading.

Also, the content providers may include uploaders, etc. directly generating content and uploading the content to the server 120.

The server 120 may store various content generated by the content providers. The content may include at least one of a video signal, an audio signal, and a text signal.

When the content providers generate content, the content providers may generate additional information with respect to the content. The additional information may be a type of metadata including references with respect to the content. The additional information may include various information, such as a content type, a generation date, a reproduction time, a content description, etc.

The content type may include information indicating whether a type of data of the content is an image, a video signal, an audio signal, etc.

The content description may include various information associated with descriptions of the content, such as a title of the content, a subject of the content, a human figure appearing in the content, an exercise part, an exercise direction, the number of people performing exercise, etc.

The server 120 may receive the search information from the electronic device 110 through the communication network 130. The server 120 may search for content based on the search information. The server 120 may search for the additional information matching the search information and may search for the content having the additional information.

Based on the search information, the server 120 may search for the content satisfying both the object identification information and the camera information. For example, in FIG. 1, based on the search information received from the electronic device 110, the server 120 may search for exercise content corresponding to the upper body, a sitting motion toward a front side, and a right and left movement.

Also, the server 120 may separately search for the content satisfying only the object identification information or the content satisfying only the camera information.

The server 120 may align the pieces of content searched in an order of relevance with respect to the search information. For example, the server 120 may align the pieces of content in the order of relevance with respect to the search information, based on the combination of various information, such as the similarity between the search information and the content, the recentness, the quality of the content, etc. The server 120 may transmit a list of the pieces of searched content to the electronic device 110 through the communication network 130.

The electronic device 110 may receive the content list from the server 120 and output the content list on a content list screen 113.

According to an embodiment, the content list screen 113 may include information about each content, the information being represented in a form including at least one of text and an image.

According to an embodiment, as illustrated in FIG. 1, the content list screen 113 may include the information about each content as a thumbnail image with respect to each content.

Also, although not shown in FIG. 1, according to an embodiment, the content list screen 113 may include the information about each content in the form of text. The content list screen 113 may include a title, a manufacturer, name, etc. of content in the form of text.

The user may select desired content from among a plurality of pieces of content included in the content list screen 113. The electronic device 110 may request, from the server 120, the content selected by the user, and may receive, from the server 120, the content and may output the content on a screen.

As described above, according to an embodiment, the electronic device 110 may: analyze an image obtained by the camera 101 to obtain information with respect to a body part, a posture, a direction, etc. of a user; obtain camera information; generate search information based on at least one of object identification information and the camera information; and transmit the search information to the server 120, in order to receive, from the server 120, content appropriate for the body part, the direction, or the posture of the user and a capability or a state of the camera and recommend the received content to the user.

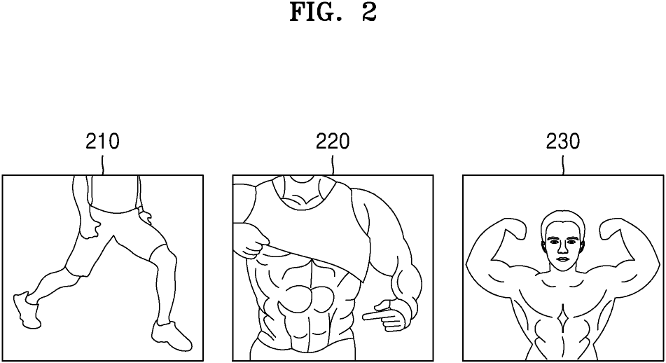

FIG. 2 is a diagram illustrating an image of an object obtained by the camera 101, according to an embodiment.

According to an embodiment, the camera 101 may capture the object and obtain the image. A user may have an aimed part of his/her body captured by the camera 101, according to content to receive a recommendation of.

For example, when the user is to receive a recommendation of content related to an exercise of the lower body, the user may have his/her lower body captured by the camera 101. When the camera 101 is fixed, the user may adjust a distance, location, etc. with respect to the camera 101, so that the fixed camera 101 may capture the lower body. The camera 101 may capture the lower body of the user to obtain an image 210 with respect to the lower body.

When the user is to perform abdominal exercise, the user may make the abdominal part of his/or body captured by the camera 101. The user may have the abdominal part captured by the camera 101 by adjusting a distance with respect to the camera 101, etc. The camera 101 may capture the abdominal part of the user to obtain an image 220 with respect to the abdominal part. Similarly, when the user is to perform waist exercise, the user may have the waist part of his/or body captured by the camera 101 so that an image with respect to the waist may be obtained.

Likewise, when the user is to perform upper body or arm exercise, the user may have his/her upper body or arms captured by the camera 101. The camera 101 may capture the upper body or arms of the user to obtain an image 230 with respect to the upper body or arms.

According to an embodiment, the electronic device 110 may analyze the image captured by the camera 101. The electronic device 110 may analyze an object in an image unit. The image unit may include a frame, a scene, a group of picture (GOP), etc.

The electronic device 110 may analyze an image to identify an object included in the image and obtain object identification information.

The electronic device 110 may obtain the object identification information from the image in various ways. According to an embodiment, the electronic device 110 may, by using at least one neural network, obtain the object identification information from the image. The electronic device 110 may, by using at least one neural network, analyze the object to identify information used for identifying the object, that is, a posture of the object, a direction of the object, a body part of the object, etc.

For example, when the camera 101 captures an abdominal part of the user to obtain the image 220 with respect to the abdominal part, the electronic device 110 may analyze the image 220 with respect to the abdominal part and may identify that the direction of the object is toward a front side of the camera 101, the object is in a standing posture, the body part of the object is the abdominal part, etc.

The electronic device 110 may generate search information based on the information about the object included in the image. The search information is information used by the server 120 to search for data, and the search information may be generated based on the information about the part or the direction of the object.

The electronic device 110 may transmit the search information to the server 120 and may receive a content list searched according to the search information from the server 120.

As described in the above example, when the object included in the image is the abdominal part, and the object is toward the front side, pieces of content searched by the server 120 based on the search information may be related to the abdominal part and toward the front side. The electronic device 110 may receive, from the server 120, a list of the pieces of content related to the abdominal part and may output the list on a screen. The user may receive the recommendation of the list of the pieces of content related to the abdominal part and may select and use desired content from the list.

As described above, according to an embodiment, the user may control the camera 101 to capture a body part related to the content to receive a recommendation about. Thus, the user may conveniently receive the recommendation about the content related to the desired body part.

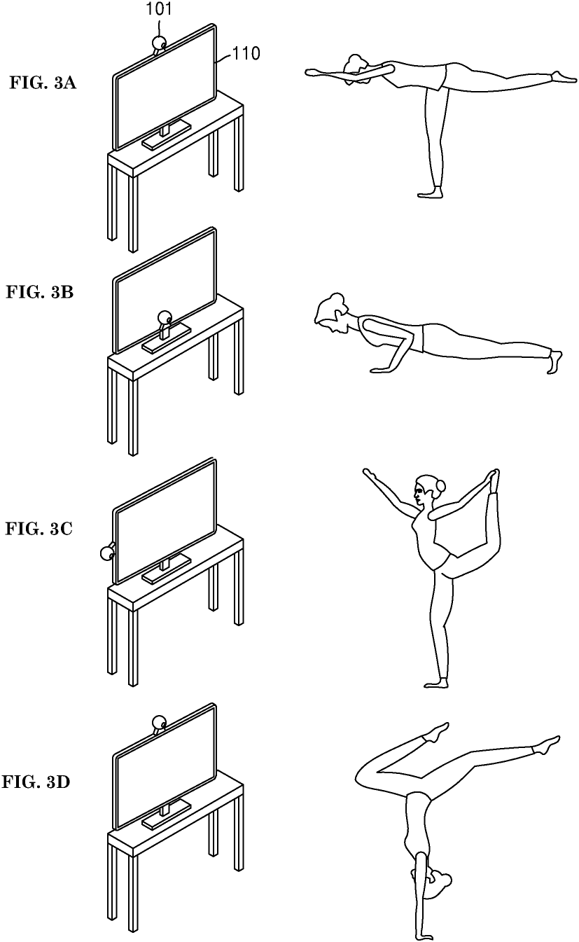

FIGS. 3A to 3D are diagrams for describing camera information, according to an embodiment.

Referring to FIG. 3A, the electronic device 110 may include the camera 101. According to an embodiment, the camera 101 may be provided in the electronic device 110 as an integral type.

According to another embodiment, the camera 101 may be a separate device from the electronic device 110. For example, when the electronic device 110 does not include a camera, or when the specification of a camera is not good even when the camera is included in the electronic device 110, a user may use a device including a camera, such as a cellular phone or a webcam, by connecting the device to the electronic device 110.

According to an embodiment, the electronic device 110 may obtain the camera information with respect to the camera 101. The camera information may be information indicating a capturing range of the camera 101 and may include at least one of information about a camera capability and information about a camera state. The information about the camera state may include at least one of information about a mode state of the camera 101, information about a mounting location of the camera 101, and information about a current setting state of the camera 101.

According to an embodiment, the information about the camera capability may be information about an available capturing range of the camera 101 and may include information related to various specifications of the camera 101, such as a capability, performance, etc. of the camera 101. The information about the camera capability may include information about whether the camera 101 supports a zoom function, a wide-angle function, or a depth function, etc. For example, when the camera 101 supports the wide-angle function, the camera 101 may adjust a viewing angle by adjusting a focal distance, according to control by a user or control by the electronic device 110. To adjust the viewing angle may denote that a range of capturing by the camera 101 may also be adjusted.

The information about the camera capability may be information related to a region or range, within which the camera 101 may capture an object, that is, a region or range in which the camera 101 is capable of capturing an object. In this sense, the information about the camera capability may be distinguished from the information about the camera state, which is related to a range in which the camera 101 currently actually captures an object. Regardless of whether or not the camera 101 currently performs a corresponding function, the electronic device 110 may obtain information about whether or not the camera 101 supports the corresponding function, as the information about the camera capability. Also, because the corresponding function may be used in the future according to setting of a user or control by the electronic device 110, even when the corresponding function is not currently used by the camera 101, the electronic device 110 may obtain the information about the camera capability.

According to an embodiment, when the electronic device 110 obtains the search information, the electronic device 110 may take into account the information about the camera capability. In this case, the content searched by the server 120 may include not only an image obtained by capturing an exercise motion by using a general viewing angle while not using a wide-angle function, but may also include an image obtained by capturing an exercise motion by using a wide viewing angle by using the wide-angle function, for example, a motion which may be performed by lying on one’s side or a motion performed by a plurality of people taking part altogether.

According to an embodiment, the information about the camera state may be information about a current capturing range of the camera 101 and may include at least one of information about a mode of the camera 101, information about a mounting location of the camera 101, and information about a current setting state of the camera 101.

When a screen image obtained by the camera 101 has a rectangular shape, the information about the mode of the camera 101 may indicate whether a current screen of the camera 101 is in a horizontal mode having a great length or a vertical mode having a great height. For example, when the camera 101 is in a state of the horizontal mode, it may be easy for the camera 101 to capture a motion of right-and-left movement or a motion having a great length, for example, a motion performed by lying on one’s side. However, it may be difficult for the camera 101 to capture a motion having a great height, for example, a motion performed in a standing posture or an up-and-down jumping motion. On the contrary, when the camera 101 is in a state of the vertical mode, it may be easy for the camera 101 to capture a motion of up-and-down movement, but it may be difficult for the camera 101 to capture a motion of right-and-left movement.

According to an embodiment, the information about the camera state may include the information about the mounting location of the camera 101. The information about the mounting location of the camera 101 may indicate whether the camera 101 is located above, beside, or below the electronic device 110.

FIG. 3A illustrates a case in which the camera 101 is in the horizontal mode and is located above the electronic device 110, and FIG. 3B illustrates a case in which the camera 101 is in the horizontal mode and is located below the electronic device 110.

As illustrated in FIG. 3A, when the camera 101 is provided in the horizontal mode as a fixed state above the electronic device 110, the camera 101 may easily capture an upper body motion of a user in a standing posture, but the camera 101 may have difficulty capturing a motion performed by a user lying down on the floor, which is not included in the capturing range. In this state, when the electronic device 110 recommends content related to motions performed lying down on the floor, because the camera 101 may not capture a motion of the user even when the user imitates a corresponding motion by watching the content, the user may not be able to compare his/her motion with the content.

On the contrary, as illustrated in FIG. 3B, when the camera 101 is provided in the horizontal mode below the electronic device 110, the camera 101 may easily capture a motion performed by a user lying down on the floor or a motion of moving arms while lying down, but the camera 101 may not capture the upper body of a user in a standing posture, which is not included in a capturing range.

According to an embodiment, the electronic device 110 may obtain the information about the current location or the mode of the camera 101 as the information about the camera state and may obtain the search information based on the information about the camera state. Thus, a body range of a user or an exercise motion which may be captured may be used for the recommendation of the content.

According to an embodiment, when the camera 101 is included in the electronic device 110 as an integral type, the electronic device 110 may pre-store a location or a mode of the camera 101 in a memory (not shown).

When the electronic device 110 and the camera 101 are separate from each other, a user may directly input location information or mode information of the camera 101 to the electronic device 110. Alternatively, the camera 101 may include at least one sensor (not shown) and may sense the location or the mode of the camera 101 by using the sensor. For example, the camera 101 may include a position sensor, such as a global positioning system (GPS), and/or a proximity sensor, and may identify the location or the mode of the camera 101 by using the position sensor and/or the proximity sensor. The camera 101 may notify the location or the mode of the camera 101 to the electronic device 110.

The electronic device 110 may obtain the information with respect to the current location or the mode of the camera 101 as the information about the camera state and may use the information about the camera state when obtaining the search information. The electronic device 110 may transmit the search information to the server 120 and may receive, from the server 120, a recommendation of content matching the search information. For example, when the camera 101 is mounted in the horizontal mode above the electronic device 110, the recommended content received from the server 120 may include content about an upper body exercise from among exercise motions. Also, when the camera 101 is mounted in the horizontal mode below the electronic device 110, the recommended content received from the server 120 may include content about a motion performed by lying down on the floor.

FIG. 3C illustrates a case in which the camera 101 is located right at the center on a side surface of the electronic device 110 and is in the vertical mode. The electronic device 110 may obtain information that the camera 101 is in the vertical mode and may also obtain location information of the camera 101. The electronic device 110 may generate the search information by taking into account the mode information and the location information of the camera 101. Here, the recommended content received from the server 120 may include a whole body motion, a motion of up-and-down movement, etc.

According to an embodiment, the information about the camera state may include information about a current setting state of the camera 101. According to an embodiment, the information about the current setting state of the camera 101 may denote information indicating a capability or performance currently executed by the camera 101 from among various capabilities of the camera 101. For example, when the camera 101 supports a zoom function, a wide-angle function, a depth function, etc., the information about the setting state may include at least one of information about whether the camera 101 executes the zoom function, information about whether the camera 101 executes the wide-angle function, and information about whether the camera 101 executes the depth function.

According to an embodiment, when the camera 101 supports the zoom function, a user may manipulate, by using a remote controller (not shown) or a touch screen, a zoom operation of the camera 101 according to a distance between the camera 101 and the user. The camera 101 may adjust a focal distance of a lens according to control by the user so as to zoom in or zoom out, thereby adjusting a captured region of an object. The user may use the zoom function to have a desired body part captured by the camera 101.

According to an embodiment, when the camera 101 is performing a zoom-in or zoom-out operation, the electronic device 110 may obtain the camera 101 performing the zoom-in or zoom-out operation as the information about the camera state. According to the information about the current state of the camera 101, for example, according to the information that the camera 101 in in a zoom-in or a zoom-out state, the electronic device 110 may obtain the information as the information about the camera state and may obtain the search information by taking into account the information about the camera state.

For example, when the user wants to perform exercise with respect to a specific body part, rather than performing a whole body motion, the user may configure the camera 101 to be in the zoom-in state so as to have the specific body part captured by the camera 101. The electronic device 110 may obtain the search information by taking into account the information about the camera state. In this case, the server 120 may search for content including exercise motions with respect to the specific body part, rather than a whole body motion.

As another example, when the camera 101 is in the zoom-out state, the server 120 may search for content including a whole body motion or a large-scale up-and-down or right-and-left motion, rather than an exercise motion with respect to a specific body part.

According to an embodiment, the camera 101 may support a wide-angle function. The user may increase a viewing angle by adjusting a focal distance of the camera 101 by using the wide-angle function. The camera 101 may capture a user in an increased range by using the wide-angle function.

According to an embodiment, when the camera 101 is capturing a user by using the wide-angle function, the electronic device 110 may obtain information that the camera 101 is in the state using the wide-angle function as the information about the camera state. When the electronic device 110 obtains the search information, the electronic device 110 may take into account the information about the camera state. In this case, the content searched by the server 120 may include an image of an exercise motion captured by a wide-angle camera, for example, an image obtained by capturing a horizontal motion, a motion performed by lying down on one’s side, a motion performed by a plurality of people taking part altogether, etc.

According to an embodiment, the camera 101 may support a depth function. For example, the camera 101 may include a depth sensor. When the camera 101 performs the depth function, the camera 101 may perform calculation on an image formed from an object through a lens and re-process the image so as to obtain a more vivid three-dimensional image of the object. The camera supporting the depth function may include a stereo-type, a time-of-flight (ToF) type, a structured patterned-type, etc. based on a method of recognizing a three-dimensional depth.

FIG. 3D illustrates a case in which the camera 101 executes the depth function. The electronic device 110 may obtain information that the camera 101 is executing the depth function as the information about the camera state. The electronic device 110 may obtain the search information by taking into account the information that the camera 101 is currently executing the depth function. For example, when the camera 101 is executing the depth function, the electronic device 110 may be aware that the camera 101 is capable of capturing a back -and-forth motion or a right-and-left motion and may reflect this information in the search information. The server 120 may search for the content based on the search information from the electronic device 110. The server 120 may search for an image obtained by capturing a motion having a depth from among exercise motions, for example, a back-and-forth motion based on the camera 101, or a motion having a breadth, for example, a right-and-left motion based on the camera 101, as the recommended content matching the search information.

As described above, according to an embodiment, the electronic device 110 may obtain the information about various capabilities or states of the camera 101 and may use this information for generating the search information, and thus, may receive, from the server 120, the content appropriate for a body range or an exercise motion of the user, which may be captured by the camera 101, and recommend the content to the user. Therefore, the user may compare an image obtained by capturing himself/herself with the image of the recommended content.

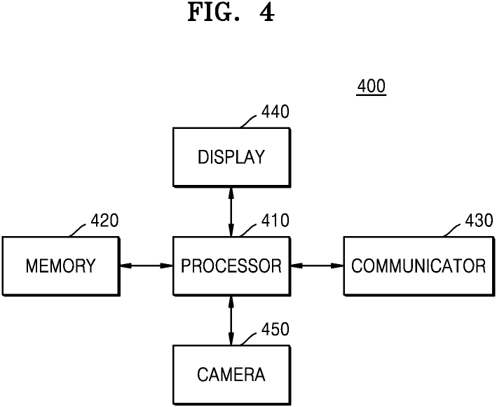

FIG. 4 is a block diagram showing internal components of an electronic device according to an embodiment. Referring to FIG. 4, an electronic device 400 may include a processor 410, a memory 420, a communicator 430, a display 440, and a camera 450.

According to an embodiment, the electronic device 400 may be an image display device. The image display device may be, but is not limited to, a digital TV capable of receiving digital broadcasting, and may be implemented as various types of electronic devices.

For example, the electronic device 400 may include at least one of a desktop computer, a smartphone, a tablet personal computer (PC), a mobile phone, a video telephone, an electronic book (e-book) reader, a laptop PC, a netbook computer, a digital camera, a personal digital assistant (PDA), a portable multimedia player (PMP), a camcorder, a navigation device, a wearable device, a smart watch, a home network system, a security system, and a medical device.

The electronic device 400 may be a stationary type or a mobile type. The electronic device 400 may be connected to a source device (not shown). The source device may include at least one of a PC, a digital versatile disk (DVD) player, a video game machine, a set-top box, an audio/video (AV) receiver, a cable receiver, a satellite broadcasting receiver, and an Internet receiver receiving content from an OTT service provider or an IPTV service provider.

According to an embodiment, the display 440 may display, on a screen, content provided by content providers. The display 440 may output, on the screen, a broadcasting program received in real time or output, on the screen, content streamed or downloaded from the server 120.

According to an embodiment, the display 440 may receive a content list from the server 120 and display the received content list on the screen. The content list may indicate a list of results searched by the server 120 based on the search information.

According to an embodiment, when a user selects content from the content list, the display 440 may receive the content from the server 120 and output the content.

According to an embodiment, the display 440 may output the content in a multi-view mode. The display 440 may split the screen into a plurality of partial screens and may display different content on each split partial screen to provide the content in the multi-view mode. The display 440 may output the pieces of content on the partial screens, respectively. For example, the display 440 may output the content received from the server 120 and a real time image with respect to an object obtained by the camera 450 on each partial screen.

When the display 440 is implemented as a touch screen, the display 440 may be used as an inputter such as a user interface, in addition to an outputter. For example, the display 440 may include at least one of a liquid crystal display, a thin-film transistor-liquid crystal display, an organic light-emitting diode, a flexible display, a three-dimensional (3D) display, and an electrophoretic display. Also, according to an implementation type of the display 440, two or more displays 440 may be provided.

The communicator 430 may connect, by using a wired or wireless communication network, the electronic device 400 to an external device or the server 120, according to control by the processor 410. Through the communicator 430, the electronic device 400 may download, from the external device, the server 120, or the like, a program or an application required by the electronic device 400 or may perform web browsing.

The communicator 430 may receive a control signal through a controller (not shown), such as a remote controller, or the like, according to control by the processor 410. The control signal may be implemented as a Bluetooth type, a radio frequency (RF) signal type, or a Wi-fi type.

According to an embodiment, the communicator 430 may transmit search information to the server 120 and may receive, from the server 120, a content list searched based on the search information. Also, when a user selects specific content, the communicator 430 may request, from the server 120, the content selected by the user and receive the corresponding content from the server 120.

The memory 420 according to an embodiment may store at least one instruction. The memory 420 may store at least one program executed by the processor 410. The memory 420 may store a pre-defined operation rule or a program. Also, the memory 420 may store data input to the electronic device 400 or output from the electronic device 400.

The memory 420 may include a storage medium of at least one of a flash memory-type, a hard disk-type, a multimedia card micro-type, a card-type memory (for example, SD or XD memory), random-access memory (RAM), static RAM (SRAM), read-only memory (ROM), electrically erasable programmable ROM (EEPROM), programmable ROM (PROM), a magnetic memory, a magnetic disk, or an optical disk.

The processor 410 may control general operations of the electronic device 400. The processor 410 may execute the at least one instruction stored in the memory 420 to control the electronic device 400 to perform functions.

According to an embodiment, the processor 410 may obtain object identification information from an image captured by the camera 450. According to an embodiment, the processor 410 may obtain camera information with respect to the camera 450. The processor 410 may obtain search information based on at least one of the object identification information and the camera information. The processor 410 may control the communicator 430 to transmit the search information to the server 120.

The processor 410 may control the display 440 to output a content list searched based on the search information and received from the server 120. When a user selects one of a plurality of contents of the content list output through the display 440, the processor 410 may request, from the server 120, the content selected by the user. The processor 410 may control the display 440 to output the content requested by the user and received from the server 120.

According to an embodiment, the processor 410 may control the display 440 to output the content received from the server 120 and the content obtained through the camera 450 via multi-views. That is, the processor 410 may control the display 440 to output multiple pieces of content via multi-views by using a plurality of partial screens.

According to an embodiment, the camera 450 may generate an image by capturing an object and may perform signal-processing on the image. The camera 450 may include an image sensor (not shown), such as a charge-coupled-device (CCD), a complementary metal-oxide semiconductor (CMOS), etc., and a lens (not shown), and the camera 450 may capture an object and obtain an image formed on a screen. The camera 450 may capture a user and obtain a video including one frame or a plurality of frames. The camera 450 may form an image on the image sensor according to information with respect to the object, and the image sensor may convert light incident through the camera 450 into an electrical signal. Also, the camera 450 may perform, on the captured image, at least one signal processing operation from among auto exposure (AE), auto white balance (AWB), color recovery, correction, sharpening, gamma, and lens shading correction.

According to an embodiment, the camera 450 may be included in the electronic device 400 as an integral type. That is, the camera 450 may be fixed at a fixed location of the electronic device 400 and may capture an object. According to another embodiment, the camera 450 may be provided as a separate device from the electronic device 400. In this case, the camera 450 may be connected to the electronic device 400 through a universal serial bus (USB) cable, a high definition multimedia interface (HDMI) cable, etc. or may be connected to the electronic device 400 through wireless communication, such as Wi-fi, Bluetooth, an RF signal, near-field communication (NFC), etc.

According to an embodiment, the camera 450 may include a plurality of cameras. For example, the camera 450 may include a camera integrally included in the electronic device 400 and an external camera separate from the electronic device 400. Each of the plurality of cameras 450 may capture the user and may obtain each image with respect to the user. The display 440 may output the plurality of images on the screen via multi-views.

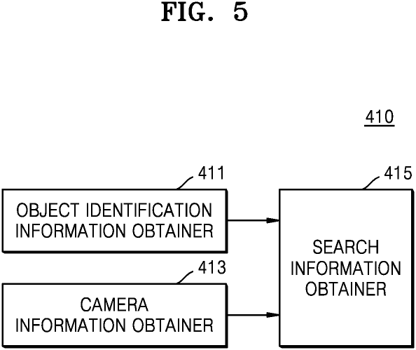

FIG. 5 is a block diagram showing internal components of the processor of FIG. 4.

Referring to FIG. 5, the processor 410 may include an object identification information obtainer 411, a camera information obtainer 413, and a search information obtainer 415.

The object identification information obtainer 411 may analyze an image obtained by using the camera 450 with respect to an object to identify the object. The object identification information obtainer 411 may obtain information about at least one of a body part of the object, a direction of the object, and a posture of the object as the object identification information.

The object identification information obtainer 411 may obtain the object identification information from the image by using various methods.

According to an embodiment, the object identification information obtainer 411 may obtain the object identification information from the image, by using at least one neural network. The electronic device 110 may implement a data recognition model for recognizing an object through a neural network and may train the implemented data recognition model by using training data. Also, the electronic device 110 may use the trained data recognition model to analyze or classify an image which is input data to analyze and classify which object is included in the image, which part of the object is included, etc.

For example, the neural network may learn a method of recognizing an object from an image, via supervised learning in which a predetermined image is provided as an input value or unsupervised learning in which the neural network directly learns types of data required for recognizing the object from the image, without additional supervision, and discovers a pattern for recognizing the object from the image. Also, for example, the neural network may learn the method of recognizing the object from the image, by using reinforcement learning using feedback with respect to whether a result of recognizing the object based on the learning is correct or not.

Also, the neural network may perform an operation for inference and prediction according to an artificial intelligence (AI) technique. In detail, the neural network may be a deep neural network (DNN) performing an operation through a plurality of layers. When the number of layers of the neural network is plural according to the number of internal layers performing the operation, that is, when the depth of the neural network performing the operation increases, the neural network may be classified as a DNN. Also, a DNN operation may include a convolution neural network (CNN) operation, etc.

The at least one neural network may be trained to identify an object from an input image.

The object identification information obtainer 411 may use the at least one neural network to obtain, from the image, a key point for each body part. The object identification information obtainer 411 may analyze the object by using the extracted key point, and thus, may identify the posture of the object, the direction of the object, the body part of the object, etc.

According to an embodiment, the camera information obtainer 413 may obtain camera information indicating a capturing range of the camera. According to an embodiment, the camera information may include at least one of information about a camera capability and information about a camera state. The information about the camera capability may include information about at least one of whether a zoom function is executed, whether a wide-angle function is executed, and whether a depth function is executed.

According to an embodiment, the information about the camera state may include at least one of information about a mounting location of the camera 450, information about a mode state of the camera 450, and information about a current setting state of the camera 450.

The camera information obtainer 413 may obtain the camera information from the camera 450 or may receive the camera information from a user. Alternatively, when the camera 450 is included in the electronic device 400 as an integral type, the camera information obtainer 413 may obtain the camera information from the memory 420.

The search information obtainer 415 may obtain search information by using at least one of the object identification information obtained from the object identification information obtainer 411 and the camera information obtained from the camera information obtainer 413. The search information obtainer 415 may generate, based on the object identification information and the camera information, the search information used for searching for data.

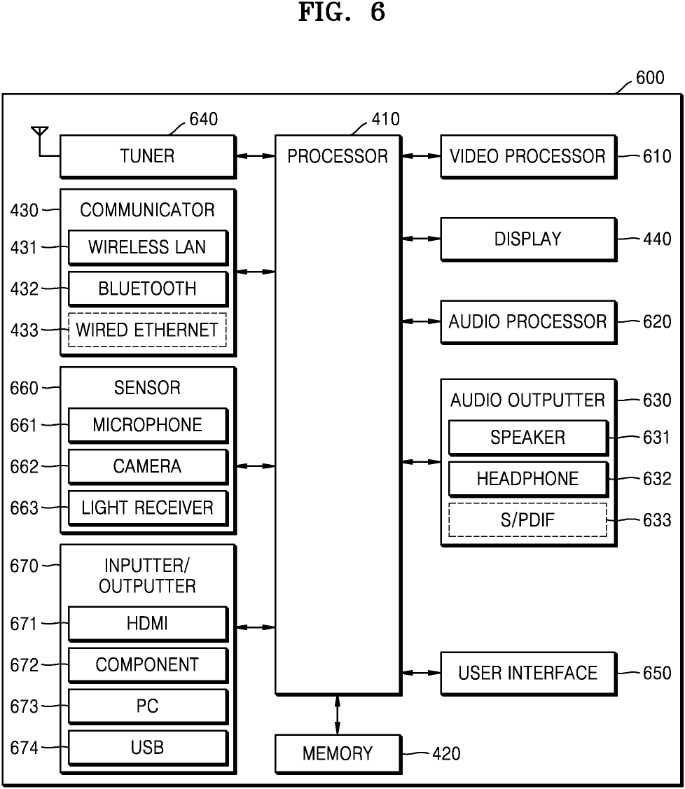

FIG. 6 is a block diagram showing internal components of an electronic device 600 according to an embodiment.

Referring to FIG. 6, in addition to the processor 410, the memory 420, the communicator 430, and the display 440, the electronic device 600 may further include a video processor 610, an audio processor 620, an audio outputter 630, a tuner 640, a user interface 650, a sensor 660, and an inputter/outputter 670.

The electronic device 600 of FIG. 6 may include the components of the electronic device 400 of FIG. 4. Thus, descriptions with respect to the processor 410, the memory 420, the communicator 430, and the display 440 that are the same as the descriptions of FIG. 4 are omitted.

The electronic device 600 of FIG. 6 may be an image display device capable of outputting content via multi-views.

The processor 410 may control general operations of the electronic device 600. The processor 410 may execute one or more instructions stored in the memory 420 to control the electronic device 600 to perform functions.

Through amplification, mixing, resonance, etc. with respect to broadcasting content, etc. received in a wired or wireless manner, the tuner 640 may tune and select only a frequency of a channel to be received by the electronic device 600 from among many radio wave components. The content received through the tuner 640 may be decoded (for example, audio-decoded, video-decoded, or additional data-decoded) and divided into audio data, video data and/or additional data. The divided audio, video, and/or additional data may be stored in the memory 420 according to control by the processor 410. According to an embodiment, the additional data may be transmitted by being included in the video data.

The communicator 430 may download a program or an application from an external device, the server 120, etc. or may perform web-browsing.

The communicator 430 may include one of a wireless local area network (LAN) 421, Bluetooth 422, and wired Ethernet 423, according to the capability and the structure of the electronic device 600. Also, the communicator 430 may include a combination of the wireless LAN 421, the Bluetooth 422, and the wired Ethernet 423.

The communicator 430 may receive a control signal through a controller (not shown), such as a remote controller or the like, according to control by the processor 410. The control signal may be implemented as a Bluetooth type, an RF signal type, or a Wi-fi type. The communicator 430 may further include other short-range wireless communication (for example, NFC (not shown) and Bluetooth low energy (BLE) (not shown)), in addition to the Bluetooth 422. According to an embodiment, the communicator 430 may transmit and receive a connection signal to and from an external device, an external camera, etc. through the short-range wireless communication, such as the Bluetooth 422 or the BLE.

The sensor 660 may sense a voice of a user, an image of the user, or an interaction of the user and may include a microphone 661, a camera 662, and a light receiver 663. The microphone 661 may receive a voice utterance of the user and may convert the received voice into an electrical signal and output the electrical signal through the processor 410.

The camera 662 may obtain an image with respect to the user by capturing the user. The camera 662 may capture an image formed on a camera screen, by using a sensor and a lens.

The light receiver 663 may receive a light signal (including a control signal). The light receiver 663 may receive, from a controller (not shown), such as a remote controller or a cellular phone, a light signal corresponding to a user input (for example, a touch input, a press input, a touch gesture, a voice, or a motion). A control signal may be extracted from the received optical signal, according to control by the processor 410.

The inputter/outputter 670 may receive video data (for example, a video signal, a still image signal, or the like), audio data (for example, a sound signal, a music signal, or the like), and additional data (for example, a content description, a content title, or a storage location of content) from an external database provided by content providers, the server 120, or the like, according to control by the processor 410. Here, the additional data may include metadata with respect to the content.

The inputter/outputter 670 may include one of an HDMI port 671, a component jack 672, a PC port 673, and a USB port 674. The inputter/outputter 670 may include a combination of the HDMI port 671, the component jack 672, the PC port 673, and the USB port 674.

The video processor 610 may process image data to be displayed on the display 440 and may perform, on the image data, various image processing operations, such as decoding, rendering, scaling, noise filtering, frame rate conversion, resolution conversion, etc. The video processor 610 may process each a plurality of pieces of content when multi-view outputting is requested.

The audio processor 620 may process the audio data. The audio processor 620 may perform various processing operations on the audio data, such as decoding, amplification, noise filtering, etc.

The audio outputter 630 may output audio included in content received through the tuner 640, audio that is input through the communicator 430 or the inputter/outputter 670, and audio stored in the memory 420, according to control by the processor 410. The audio outputter 630 may include at least one of a speaker 631, a headphone output terminal 632 or a Sony/Philips digital interface (S/PDIF) output terminal 633.

The user interface 650 may receive a user input for controlling the electronic device 600. The user interface 650 may include, but is not limited to, various types of user input devices including a touch panel configured to sense a user’s touch, a button configured to receive user’s push manipulation, a wheel configured to receive user’s rotation manipulation, a keyboard, a dome switch, a microphone configured to recognize a sound, a motion sensor configured to sense a motion, and the like.

Also, when the electronic device 600 is manipulated by a remote controller (not shown), the user interface 650 may receive a control signal from the remote controller. The remote controller may control the electronic device 600 by using short-range wireless communication including infrared communication or Bluetooth. The remote controller may control the functions of the electronic device 600 through the user interface 650 by using at least one of a provided key or button, a touch pad, a microphone (not shown) capable of receiving a voice of a user, and a sensor (not shown) capable of recognizing a motion of a controller.

According to an embodiment, the user may control, by using the user interface 650, the electronic device 600 to execute various functions of the electronic device 600.

The user may use the user interface 650 to determine whether or not to execute a zoom-in, zoom-out, wide-angle, or depth function, etc. of the camera 662, etc., so as to adjust a state of the camera. Also, the user may select one from a content list output on the display 440, by using the user interface 650.

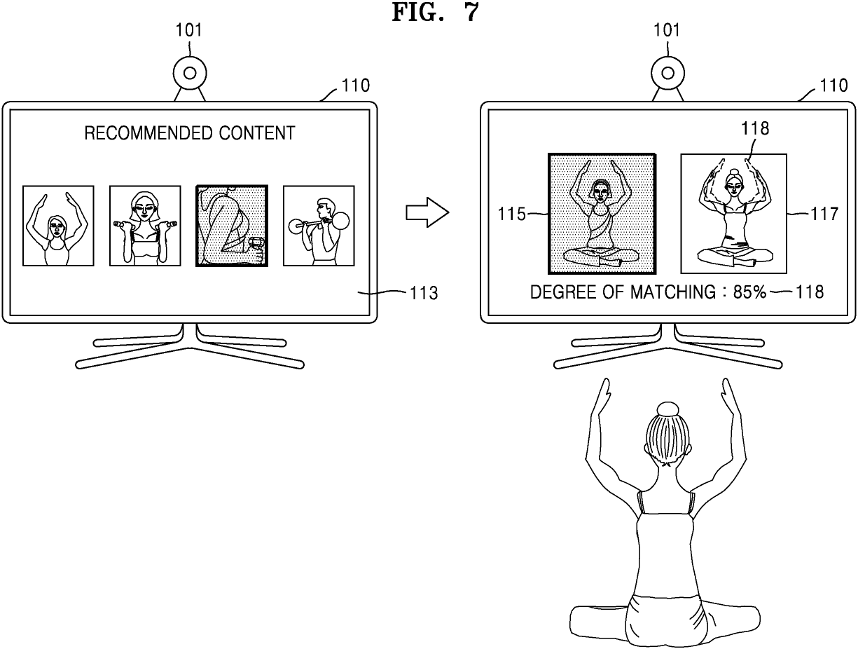

FIG. 7 is a diagram for describing an operation of outputting, via multi-views, a motion of a user and a motion of a comparative subject included in content recommended by an electronic device, according to an embodiment.

According to an embodiment, the electronic device 110 may obtain object identification information from an image obtained by capturing a user by using the camera 101 and may obtain camera information with respect to the camera 101. The electronic device 110 may obtain search information based on at least one of the object identification information and the camera information and may transmit the search information to the server 120.

The electronic device 110 may receive, from the server 120, a searched content list and may output the list.

The left figure of FIG. 7 illustrates a case in which the electronic device 110 outputs the content list received from the server 120 on the content list screen 113. A user may select desired content by viewing the content list screen 113. The electronic device 110 may request the content selected by the user from the server 120 and may download or stream the content from the server 120 and output the content on a screen.

According to an embodiment, the electronic device 110 may provide a multi-streaming service to provide a more diverse content experience to the user. The multi-streaming service may denote a service in which the electronic device 110 receives multi-streams, processes each of the multi-streams, and provides different pieces of content on a plurality of regions of a display screen. The multi-streaming service may also be referred to as a multi-view service or a multi-screen service.

The electronic device 110 may split a display into a plurality of screens and may display different content on each split screen, thereby providing the content in a multi-view mode. In the multi-view mode, each split screen of the display may also be referred to as a partial screen.

The content displayed in the multi-view mode may include one or more from among broadcasting content directly received from a broadcasting station through an RF signal, broadcasting content received through an external source, and content received from the server 120 providing content through the Internet.

Also, the electronic device 110 may obtain a real time image with respect to a user by using the camera 101 and may output the real time image on the partial screens.

As illustrated in the right figure of FIG. 7, the electronic device 110 may receive, from the server 120, the content selected by the user and may output the content on a first partial screen 115 as a comparative screen. Also, the electronic device 110 may output the real time image with respect to the user obtained by using the camera 101 on a second partial screen 117.

The user may compare his/her motion with a motion of a comparative subject appearing in the content selected by the user, through the multi-view screen of the electronic device 110.

The user may imitate the motion of the comparative subject by viewing the motion of the comparative subject. Also, by comparing his/her motion with the motion of the comparative subject via multi-views, the user may correct the motion.

The electronic device 110 may output matching information 118 indicating whether or not the motion of the user matches the motion of the comparative subject. The matching information 118 may include information indicating a degree of similarity between the motions of the user and the comparative subject as a percentage, or information virtually indicating the motion of the comparative subject above an image of the user, when the motions of the user and the comparative subject do not match each other.

As described above, according to an embodiment, the electronic device 110 may recommend content tailored for the user by taking into account a body part of the user captured by the user 101 by using the camera 101 or a current camera state, and may show content selected by the user from the recommended content together with the image of the user via multi-views, so that the motion accuracy of the user with respect to the comparative subject may be increased.

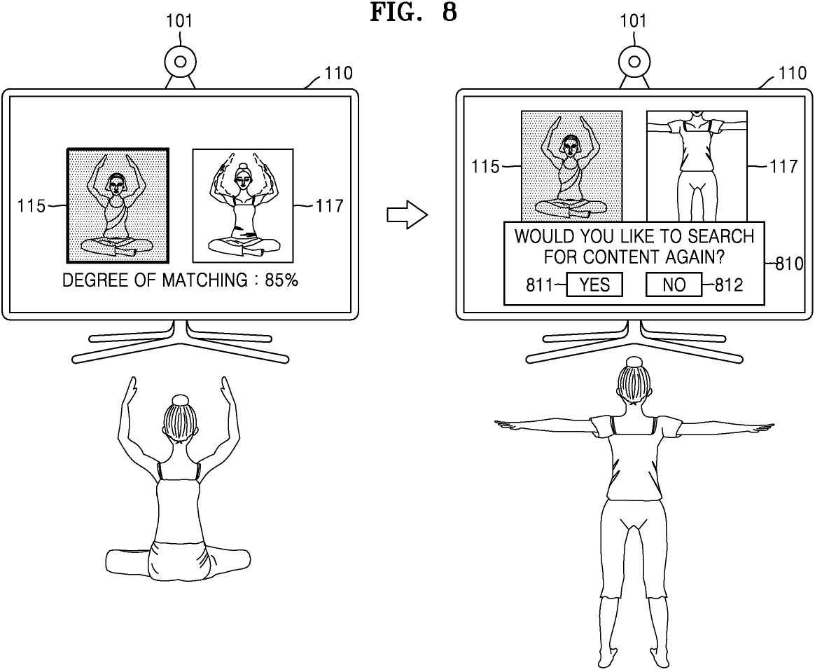

FIG. 8 is a diagram for describing an electronic device outputting an interface screen for interaction with a user, when a body part of the user captured by a camera is changed, according to an embodiment.

The left figure of FIG. 8 illustrates a case in which the electronic device 110 outputs a real time image with respect to a user and an image of content selected by the user, via multi-views. The electronic device 110 may output an image of a comparative subject on the first partial screen 115 and output the real time image with respect to the user on the second partial screen 117. Referring to the left figure of FIG. 8, it is shown that the comparative subject output on the first partial screen 115 and the user output on the second partial screen 117 are both performing a predetermined motion by sitting on the floor.

The user may want to switch the exercise motion to perform other exercise. For example, the user, who was exercising by sitting on the floor as shown in the left figure of FIG. 8, may wish to stand up and perform other exercise which may be performed in the standing posture as shown in the right figure of FIG. 8. In this case, a real time image of the user in the standing posture may be output on the second partial screen 117 of the electronic device 110.

According to an embodiment, the electronic device 110 may analyze the real time image with respect to the user obtained by using the camera 101 and may identify whether object identification information is changed from previous object identification information by a value greater than or equal to a reference value. The object identification information includes at least one of a body part of the object, a posture of the object, and a direction of the object, and thus, the electronic device 110 may identify that the object identification information is changed, when at least one of the body part of the user, the posture of the user, and the direction of the user is changed by a value greater than or equal to a predetermined reference value.

According to an embodiment, when the object identification information is changed, the electronic device 110 may output an interface screen 810 asking the user whether or not to search for the content again. As shown in the right figure of FIG. 8, the interface screen 810 may be displayed as a text window on a partial region of a screen of the electronic device 110. A size, an output location, a transparency, and/or a shape of the user interface screen 810 may be variously modified.

When a user input selecting a menu of “yes” is received through the interface screen 810, the electronic device 110 may obtain the search information again. The electronic device 110 may obtain again the changed search information based on the changed object identification information and may transmit the changed search information to the server 120.

The server 120 may search for the content again based on the changed search information received from the electronic device 110. The server 120 may transmit a list of pieces of content obtained based on the changed search information to the electronic device 110.

According to another embodiment, the user may change a location, mode, functional state, etc. of the camera 101. For example, the user may change the mode of the camera 101 from a vertical mode to a horizontal mode and may change the location, etc. of the camera 101.

According to an embodiment, when the function, the mounting location, or the mode of the camera 101 is changed, the electronic device 110 may identify that the camera information, more specifically, the information about the camera state, is changed. When the electronic device 110 identifies that the information about the camera state is changed, the electronic device 110 may output the interface screen 810 asking the user whether or not to search for content again according to the changed state of the camera 101.

As described above, according to an embodiment, when the camera information or the object identification information is changed, the electronic device 110 may ask the user whether or not to search for content again to determine whether or not to search for new content according to the body part or the direction of the user or the camera state.

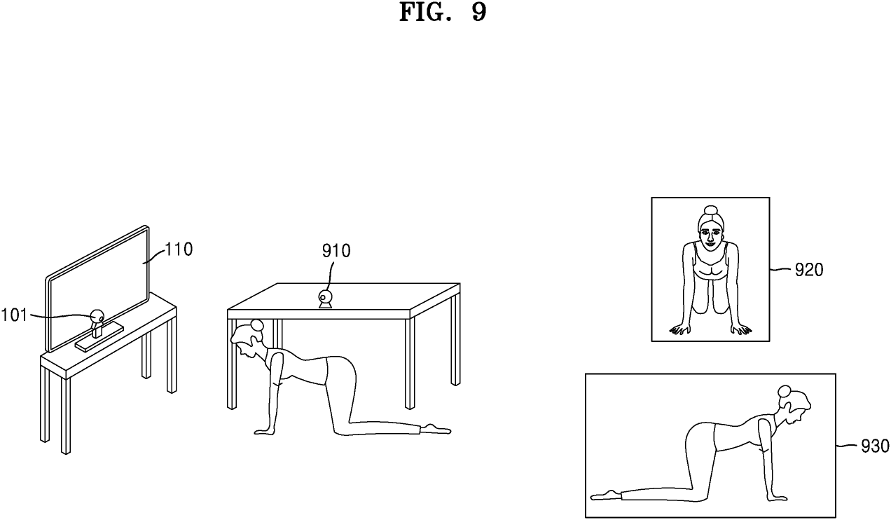

FIG. 9 illustrates a case in which a real time image with respect to an object is obtained by using a plurality of cameras, according to an embodiment.

Referring to FIG. 9, the electronic device 110 may obtain an image with respect to a user by using the plurality of cameras. According to an embodiment, with reference to FIG. 9, the user may use two cameras 101 and 910. For example, a first camera 101 may be integrally included in the electronic device 110, and the second camera 910 may be a separate device from the electronic device 110 and may be included in a user terminal.

According to an embodiment, the user terminal may include the second camera 910 and may be implemented as various types of devices capable of performing communication with the electronic device 110. For example, the user terminal may include at least one of a desktop computer, a smartphone, a table PC, a mobile phone, a video telephone, an e-book reader, a laptop PC, a netbook computer, a digital camera, a PDA, a PMP, a camcorder, a navigation device, a wearable device, and a smart watch. The user terminal may be stationary or mobile.

The user terminal may transmit a real time image with respect to the user obtained by the second camera 910 to the electronic device 110 through a wired or wireless communication network through which the user terminal is connected to the electronic device 110.

The electronic device 110 may obtain a plurality of images with respect to the same user by using the plurality of cameras. The plurality of cameras may capture the user from different directions or angles. Also, the cameras may have the same camera information or different camera information. For example, the first camera 101 may be in a vertical mode and located at a lower end of the electronic device 110, and the second camera 910 may also be located at a lower end of the electronic device 110 at the same height as the first camera 101 but may be in a horizontal mode.

The right figure of FIG. 9 illustrates an image obtained by capturing the user. The electronic device 110 may obtain a first image 920 by capturing the user by using the first camera 101. The first image 920 obtained by using the first camera 101 may be an image obtained by capturing a front side of the user.

The electronic device 110 may obtain a second image 903 by using the second camera 910. The second image 930 obtained by using the second camera 910 may be an image obtained by capturing a lateral side of the user.

According to an embodiment, the electronic device 110 may generate images of the same object in different directions by using the different cameras and, based on the images, may obtain search information. According to an embodiment, the electronic device 110 may obtain the search information for each camera. That is, the electronic device 110 may obtain first object identification information from the first image 920 obtained by using the first camera 101. Also, the electronic device 110 may obtain first camera information with respect to the first camera 101. The electronic device 110 may obtain first search information based on at least one of the first object identification information and the first camera information.

Based on a similar method, the electronic device 110 may obtain second object identification information from the second image 930 obtained by using the second camera 910 and may obtain second camera information with respect to the second camera 910. The electronic device 110 may obtain second search information based on at least one of the second object identification information and the second camera information.

The electronic device 110 may generate search information including a set of the first search information and the second search information and transmit the search information to the server 120. The server 120 may receive the search information from the electronic device 110 and search for content matching the search information.

As described above, according to an embodiment, the electronic device 110 may obtain the plurality of images with respect to the user by using the plurality of cameras and may obtain the search information for each camera.

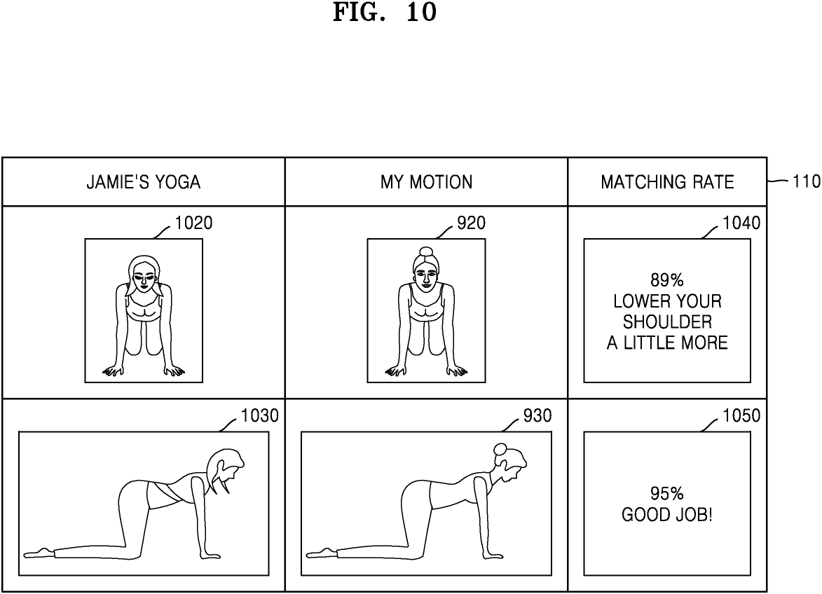

FIG. 10 is a diagram for describing an operation of outputting, via multi-views, a motion of a user and a motion of a comparative subject included in content recommended by an electronic device, when a plurality of images with respect to the user are obtained, according to an embodiment.

According to an embodiment, when the electronic device 110 generates the search information including the set of the first search information and second search information and transmits the search information to the server 120, as described with reference to FIG. 9, the server 120 may receive the search information from the electronic device 110 and may search for content corresponding to the search information.

When the search information received from the electronic device 110 includes a set of plurality of pieces of search information, the server 120 may search for content including a set of pieces of content respectively corresponding to the pieces of search information of the set, as recommended content.

For example, when the server 120 receives, from the electronic device 110, the search information including the set of the first search information and the second search information, the server 120 may search for the content including pieces of content respectively corresponding to the first search information and the second search information. That is, the server 120 may use the first search information to search for an image capturing a body part similar to the first image 920, the image having a direction similar to the first image 920 and being captured by a camera in a state similar to the first image 920. Also, the server 120 may use the second search information to search for an image capturing a body part similar to the second image 930, the image having a direction similar to the second image 930 and being captured by a camera in a state similar to the second image 930. Also, the server 120 may search for the content including a set of the images respectively searched according to the first search information and the second search information. That is, the server 120 may search for the content including a set of pieces of content captured from a front side and a lateral side similarly to the first image 920 and the second image 930, respectively. When the plurality of pieces of content are searched, the server 120 may transmit a content list to the electronic device 110.

FIG. 10 illustrates a case in which, when the server 120 transmits content including a set of comparative images searched in correspondence to first search information and second search information, the content is output together with a real time image with respect to a user.

In FIG. 10, the electronic device 110 may output the real time image with respect to the user. As illustrated in FIG. 9, the electronic device 110 may output real time images 920 and 930 with respect to the user respectively obtained by the plurality of cameras 101 and 910.

Also, according to an embodiment, the electronic device 110 may receive, from the server 120, a first comparative image 1020 and a second comparative image 1030 respectively searched in correspondence to the first image 920 and the second image 930. The electronic device 110 may output the first comparative image 1020 and the second comparative image 1030 together with the first image 920 and the second image 930 via multi-views, by using a partial screen corresponding to each of the images.

According to an embodiment, the electronic device 110 may obtain first matching information 1040 by comparing the first image 920 with the first comparative image 1020. The electronic device 110 may output the first matching information 1040 next to the first image 920 and the first comparative image 1020.

Also, the electronic device 110 may obtain second matching information 1050 by comparing the second image 930 with the second comparative image 1030. The electronic device 110 may output the second matching information 1050 next to the second image 930 and the second comparative image 1030.

As described above, according to an embodiment, the electronic device 110 may output the plurality of images with respect to the user obtained by using the plurality of cameras, together with the comparative images respectively searched in correspondence to the plurality of images. The electronic device 110 may output the images the same as or similar to each other with respect to a motion or direction of the user, a camera state, etc. altogether on the screen, so that the user may compare his/her motion with motions of a comparative subject at various angles. Therefore, the motion accuracy may be increased.

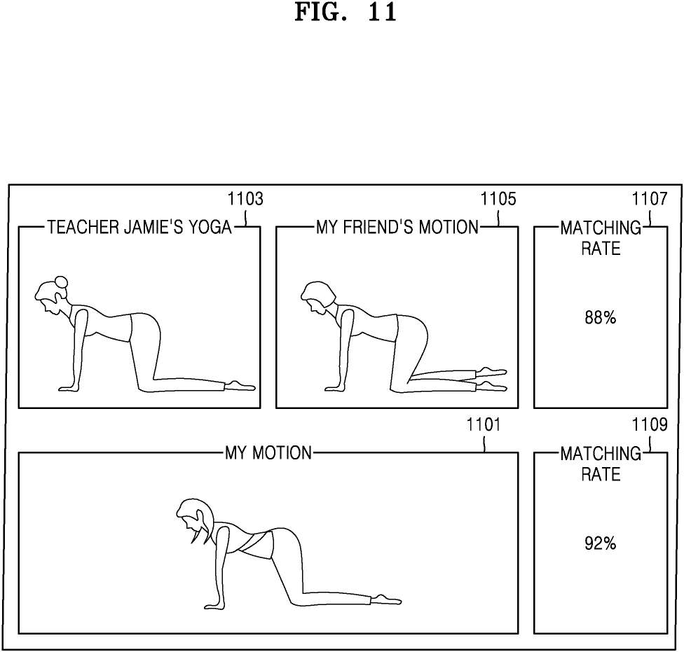

FIG. 11 is a diagram for describing an operation of outputting a motion of a comparative subject included in content, a motion of a user, and a motion of a third party altogether, via multi-views, according to an embodiment.

The electronic device 110 may obtain search information based on at least one of object identification information and camera information and may transmit the search information to the server 120. The server 120 may search for content by using the search information and may transmit the content to the electronic device 110.

Referring to FIG. 11, the electronic device 110 may output an image 1101 with respect to a user obtained by a camera, together with content 1103 received from the server 120.

According to an embodiment, the electronic device 110 may also output an image 1105 of the third party via multi-views. The image 1105 of the third party may be received from an electronic device (not shown) of the third party connected through a communication network. According to an embodiment, the electronic device 110 may directly perform communication with the electronic device of the third party through a wired or wireless communication network. For example, the electronic device 110 and the electronic device of the third party may transmit and receive information to and from each other through a peer to peer (P2P) method. The electronic device 110 may receive the image 1105 of the third party from the electronic device of the third party and may output the image 1105 via multi-views.

Alternatively, according to another embodiment, both of the electronic device 110 and the electronic device of the third party may be connected to the same server 120 through a communication network. The server 120 used in this case may be, for example, a cloud server 120. The cloud server 120 may be the same as the server 120 searching for the content based on the search information and providing the searched content to the electronic device 110, or the cloud server 120 may be different from this server 120. The electronic device 110 may communicate with the cloud server 120 by accessing an application, etc. Also, the electronic device of the third party may perform communication by accessing the cloud server 120. The electronic device 110 may receive a real time image of the third party from the cloud server 120 and may output the real time image of the third party together with the image of the user. The third party may be, for example, a friend or an acquaintance of the user. Also, the third party may have agreed on sharing of the image with the user.

According to an embodiment, the user and the third party may imitate a motion by watching the same content 1103.

The electronic device 110 may output the image 1101 of the user obtained by using the camera and the image 1105 of the third party, together with the content 1103 received from the server 120, via multi-views.

As illustrated in FIG. 11, the electronic device 110 may obtain matching information 1107 by comparing a motion of the third party included in the image 1105 of the third party with a motion of a comparative subject in the content 1103 received from the server 120 and may output the matching information 1107. Also, the electronic device 110 may obtain matching information 1109 by comparing a motion of the user in the image 1101 of the user with the motion of the comparative subject in the content 1103 and may output the matching information 1109.

As described above, according to an embodiment, the electronic device 110 may obtain an image with respect to a third party present in a different location from the user and may output the image with respect to the third party together with an image of the user, on one screen, and thus, may provide experiences to the user as if the user and the third party are exercising in the same space.

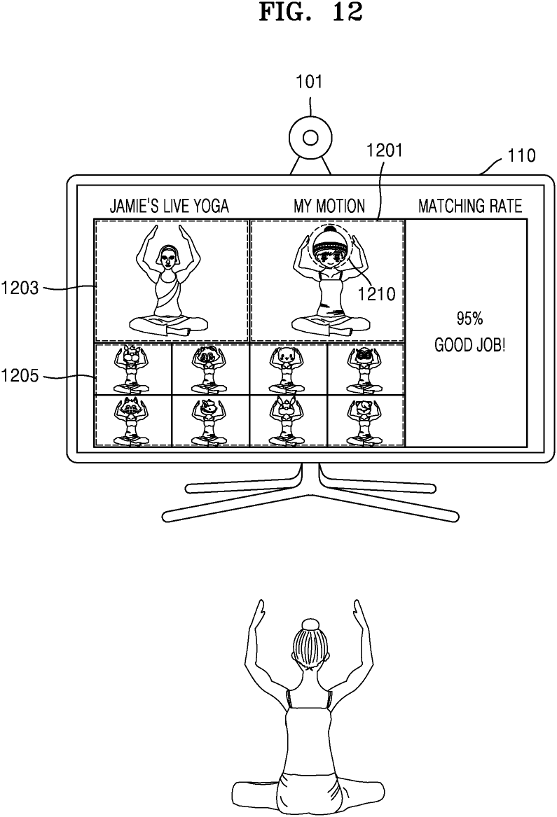

FIG. 12 is a diagram for describing an operation of outputting a motion of a comparative subject included in content, a motion of a user, and a motion of a third party altogether, via multi-views, according to an embodiment.

Referring to FIG. 12, the electronic device 110 may output an image 1201 of the user obtained by the camera 101 and content 1203 received from the server 120, together with an image 1205 of the third party, via multi-views.

In certain cases, the user may not want to share his/her motion with the third party. For example, when the third party is the unspecified public rarely known by the user, the user may want to have the minimum privacy by hiding his/her face or a portion of his/her body part.

According to an embodiment, the user may generate a character which the user is fond of, by using the electronic device 110. Alternatively, the user may replace a portion of his/her body part by using an animation, an emoticon, a sticker, a figure, etc.

The electronic device 110 may replace a portion of the image 1201 of the user with a character, an emoticon, etc. selected by the user. The electronic device 110 may identify a facial part of the user by analyzing the image 1201 of the user and may replace the facial part with the character, the emoticon, etc. selected by the user. The electronic device 110 may transmit, to the cloud server 120, the image of the user, in which the facial part is replaced by the character, the emoticon, etc.

FIG. 12 illustrates a case in which the electronic device 110 hides a facial part of the image 1201 of the user so that the face of the user is invisible to a third party.

Likewise, by using the same method as described above, the third party may also share with the user an image in which the face or a specific body part is replaced by a desired character, animation, emoticon, icon, etc.

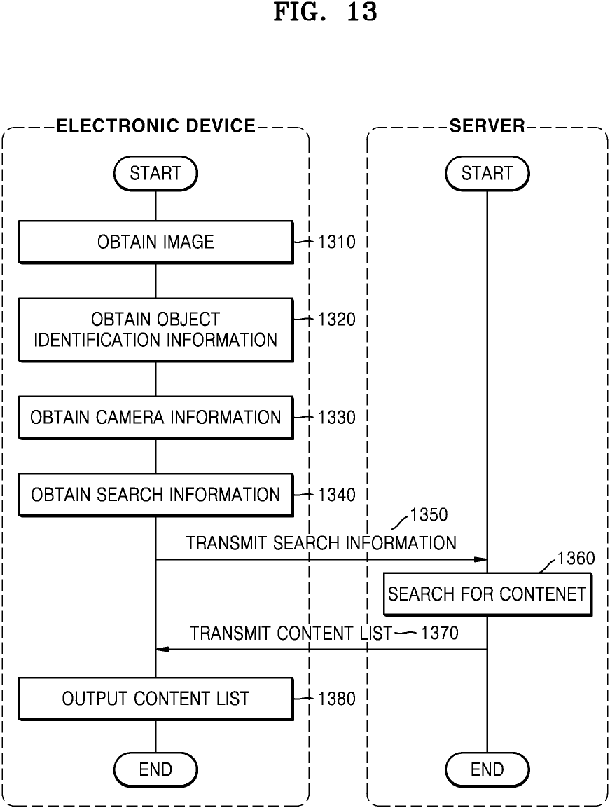

FIG. 13 is a flowchart of an operating method of an electronic device, according to an embodiment.

Referring to FIG. 13, the electronic device may obtain an image with respect to a user by using a camera in operation 1310. The electronic device may obtain object identification information by analyzing the image in operation 1320. According to an embodiment, the object identification information may include information about at least one of a body part of an object and a direction of the object.

The electronic device may obtain camera information in operation 1330. According to an embodiment, the camera information may include at least one of information about a camera capability and information about a camera state.

The information about the camera capability may include information about at least one of whether a zoom function is supported, whether a wide-angle function is supported, and whether a depth function is supported.

The information about the camera state may include at least one of information about a mounting location of the camera, information about a mode state of the camera, and information about a current setting state of the camera. The electronic device may obtain search information based on at least one of the object identification information and the camera information in operation 1340.

The electronic device may transmit the search information to the server 120 in operation 1350.

The server 120 may receive the search information from the electronic device and search for content matching the search information in operation 1360. When the searched content includes a plurality of pieces of content, the server 120 may transmit, to the electronic device, the searched content in the form of a list in operation 1370.

The electronic device may output a content list received from the server 120 on a screen in operation 1380.

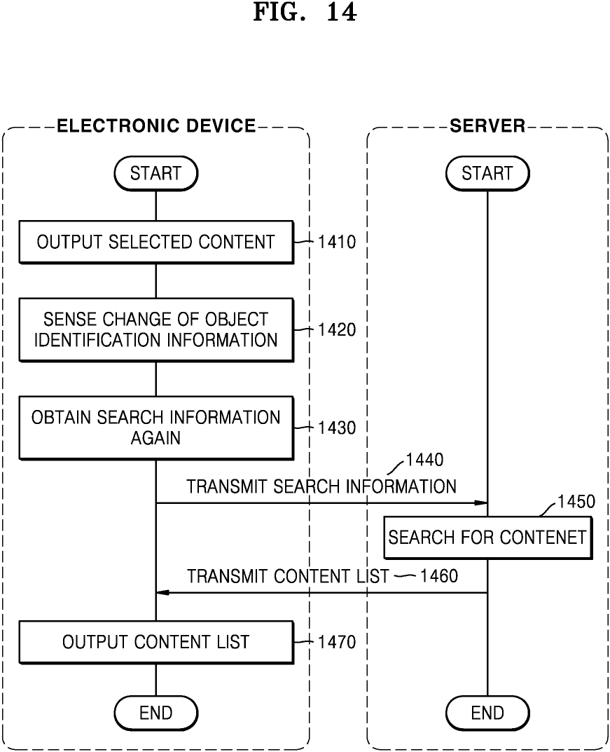

FIG. 14 is a flowchart of an operating method of an electronic device, according to an embodiment.

Referring to FIG. 14, the electronic device may output content selected by a user in operation 1410. The electronic device may output the content and sense a change of object identification information in operation 1420. For example, the electronic device may sense the change of the object identification information, when a body part or a direction of the user is changed by a value greater than or equal to a reference value.

The electronic device may obtain new search information in correspondence to the change of the object identification information in operation 1430. The electronic device may transmit changed search information to the server 120 in operation 1440, so that the server 120 may search for content based on the new search information in operation 1450. The electronic device may receive, from the server 120, content searched based on the changed search information in operation 1460 and may output the content in operation 1470.

The electronic device and the operating method thereof according to embodiments may also be implemented by a recording medium including instructions executable by a computer, such as a program module executable by the computer. The computer-readable recording medium may be an arbitrary available medium accessible by a computer and includes all of volatile and non-volatile media and detachable and non-detachable media. Also, the computer-readable recording medium may include both of a computer storage medium and a communication medium. The computer storage recording medium includes all of volatile and non-volatile media and detachable and non-detachable media that are realized by an arbitrary method or technique for storing information, such as computer-readable instructions, data structures, program modules, or other data. The communication medium typically includes computer-readable instructions, data structures, program modules, or other data of modulated data signals, such as carrier waves, or other transmission mechanisms, and includes an arbitrary data transmission mechanism.

Also, in this specification, a “unit” may refer to a hardware component, such as a processor or a circuit, and/or a software component executed by a hardware component such as a processor.

Also, the operating method of the electronic device according to an embodiment of the disclosure described above may be implemented by a computer program product including a recording medium having stored thereon a computer program for executing an operating method of an electronic device, the operating method including: obtaining, from an image obtained by capturing an object by using a camera, object identification information with respect to the object; obtaining camera information with respect to the camera; obtaining search information based on at least one of the object identification information and the camera information; transmitting the search information to a server; receiving, from the server, a content list searched based on the search information; and outputting the received content list.

The above descriptions are given for examples, and it will be understood by one of ordinary skill in the art that changes in form and details may be made therein without departing from the technical spirit or essential features of the disclosure. Therefore, it will be understood that the embodiments described above are examples in all aspects and are not limiting of the scope of the disclosure. For example, each of components described as a single unit may be executed in a distributed fashion, and likewise, components described as being distributed may be executed in a combined fashion.

What is claimed is:

1. An operating method of an electronic device, the operating method comprising:
obtaining object identification information of an object based on an image obtained from a camera;
obtaining camera information indicating a capturing range of the camera;
obtaining search information based on at least one of the object identification information and the camera information;
transmitting the search information to a server;
receiving a content list from the server wherein the content list is searched based on the search information; and
outputting the content list.

2. The operating method of claim 1, wherein the object identification information comprises information about at least one of a body part of the object, a posture of the object, and a direction of the object.

3. The operating method of claim 1, wherein the camera information comprises at least one of information about a camera capability and information about a camera state, and
the information about the camera state comprises at least one of information about a current setting state of the camera, information about a location of the camera, and information about a mode of the camera.

4. The operating method of claim 1, further comprising:
identifying a change in at least one of the object identification information and the camera information;
obtaining changed search information based on the change;
transmitting, to the server, the changed search information, and receiving, from the server, a changed content list, wherein the changed content list is searched based on the changed search information; and
outputting the changed content list.

5. The operating method of claim 4, further comprising, based on identifying the change in at least one of the object identification information and the camera information, outputting an interface screen configured to determine whether or not to perform a new content search.

6. The operating method of claim 1, further comprising:
selecting content from the content list; and
outputting the selected content and a real time video of the object captured by the camera, via multi-views, by using a plurality of partial screens.

7. The operating method of claim 6, further comprising:
obtaining matching information by comparing a motion of a comparative subject included in the selected content with a motion of the object included in the real time video; and
outputting the matching information.

8. The operating method of claim 6, further comprising receiving the real time video of a third party,
wherein the outputting of the selected content and the real time video of the object captured by the camera, via multi-views, by using the plurality of partial screens comprises outputting the selected content, the real time video of the object captured by the camera, and the real time video of the third party, via multi-views, by using the plurality of partial screens.

9. The operating method of claim 6, wherein the camera comprises a plurality of cameras, wherein the plurality of cameras capture the object from different views,
obtaining the search information comprises obtaining respective search information for each of the plurality of cameras, and
receiving the content list comprises receiving a content list including, as a set, respective content for each of the plurality of cameras, searched in correspondence to the respective search information obtained for each of the plurality of cameras.

10. The operating method of claim 9, wherein outputting the selected content and the real time video of the object captured by the camera, via multi-views, by using the plurality of partial screens, comprises outputting the respective content for the plurality of cameras and the real time video, by comparing, based on an identical direction, the respective content for the plurality of cameras included in the selected content with the real time video of the object captured by the camera.

11. An electronic device comprising:
a display;
a memory storing one or more instructions; and
a processor configured to execute the one or more instructions stored in the memory to:
obtain object identification information of an object, from an image obtained from a camera;
obtain camera information indicating a capturing range of the camera;
obtain search information based on at least one of the object identification information and the camera information;
transmit, to a server, the search information; and
output, through the display, a content list, the content list being searched based on the search information and received from the server.

12. The electronic device of claim 11, wherein the object identification information comprises information about at least one of a body part of the object, a posture of the object, and a direction of the object.

13. The electronic device of claim 11, wherein the camera information comprises at least one of information about a camera capability and information about a camera state, and
the information about the camera state comprises at least one of information about a current setting state of the camera, information about a location of the camera, and information about a mode of the camera.

14. The electronic device of claim 11, wherein the processor is further configured to execute the one or more instructions to:
identify a change in at least one of the object identification information and the camera information;
obtain changed search information based on the change;
transmit, to the server, the changed search information; and
output, through the display, a changed content list that is searched based on the changed search information and received from the server.

15. The electronic device of claim 14, wherein the processor is further configured to execute the one or more instructions to:
based on identifying the change in at least one of the object identification information and the camera information, output an interface screen configured to determine whether or not to perform a new content search.

16. The electronic device of claim 11, further comprising a user interface,
wherein the processor is further configured to execute the one or more instructions to:
receive a selection of content from the content list through the user interface; and
output the selected content and a real time video of the object captured by the camera, via multi-views, by using a plurality of partial screens.

17. The electronic device of claim 16, wherein the processor is further configured to execute the one or more instructions to:
obtain matching information by comparing a motion of a comparative subject included in the selected content with a motion of the object included in the real time video; and
output the matching information through the display.

18. The electronic device of claim 16, wherein the camera comprises a plurality of cameras, wherein the plurality of cameras capture the object from different views,
wherein the processor is further configured to execute the one or more instructions to:
obtain the search information comprises obtaining respective search information for each of the plurality of cameras, and
receive the content list including, as a set, respective content for each of the plurality of cameras, searched in correspondence to the respective search information obtained for each of the plurality of cameras, from the server.

19. The electronic device of claim 18, the display outputs the respective content for the plurality of cameras and the real time video, by comparing, based on an identical direction, the respective content for the plurality of cameras included in the selected content with the real time video of the object captured by the camera.

20. A non-transitory computer-readable recording medium having recorded thereon a program for implementing an operating method of an electronic device, the operating method comprising:
obtaining object identification information of an object based on an image obtained from a camera;
obtaining camera information indicating a capturing range of the camera;
obtaining search information based on at least one of the object identification information and the camera information;
transmitting the search information to a server;
receiving a content list from the server, wherein the content list is searched based on the search information; and
outputting the content list.
